(19) United States
(12) Patent Application Publication
(10) Pub. No.: US 2024/0263651 A1
(43) Pub. Date: Aug. 8, 2024

(54) Digital Integrated System for Calibration

(71) Applicant: 3DATX Corporation, Buffalo, NY (US)

(72) Inventors: John SCHNIER, Clarence, NY (US); Dominic Santo DARRIGO, Buffalo, NY (US); David W. Miller, Clarence, NY (US)

(21) Appl. No.: 18/290,209

(22) PCT Filed: May 10, 2022
(86) PCT No.: PCT/US22/28640

§ 371 Date: Nov. 10, 2023

Related U.S. Application Data
(60) Provisional application No. 63/186,761, filed on May 10, 2021.

(51) Int. Cl. F15B 19/00

(52) U.S. Cl. CPC F15B 19/002

(57) ABSTRACT

A system with a base unit and a control unit generates a controlled distribution of a fluid. The base unit has one or more inlets, an outlet, and at least one valve configured to control gas flow through the base unit from the inlet to the outlet. The control unit can be detachably connected to the base unit. The control unit includes a battery, a processor, and a wireless communication unit.

### CROSS-REFERENCE TO RELATED APPLICATIONS

This application claims priority to the provisional patent application filed May 10, 2021 and assigned U.S. App. No. 63/186,761, the disclosure of which is hereby incorporated by reference.

### FIELD OF THE DISCLOSURE

This disclosure relates to a gas delivery and/or calibration system and a two-way regulator device.

### BACKGROUND OF THE DISCLOSURE

Gaseous emissions can have an adverse effect on the environment, having the potential, depending on level of exposure and composition, to be both profoundly harmful to human health and detrimental to ecosystems and infrastructure alike. As a result, many industries face ever-increasing pressure to monitor, reduce, and/or limit certain emissions generated by internal combustion engines, stacks, other systems that generate emissions, or other sources.

Vehicle and transportation sector-related emissions continue to be a leading source of greenhouse gas (GHG) and air pollution in urban areas around the globe. As an example, there were over 279 million vehicles in the United States in 2019 that emitted 33% (1,750 million metric tons) of total U.S. CO₂ emissions. In the same year, the U.S. transportation sector share of total U.S. emissions for CO, NOₓ, and particulate matter (PM) were 54%, 59%, and 8%, respectively. Therefore, there is a focus on emission reduction tactics that typically fall into two categories: current fleet inventory upgrade (e.g., roadside and/or engine bay inspection and maintenance (I/M) programs, aftermarket engine/vehicle/fuel programs, etc.) or new vehicle manufacturing (e.g., revisions of standards for newly manufactured vehicles, etc.).

Accurate emission(s) data are needed to properly evaluate the impact of emission reduction strategies. One challenge currently faced is the routine calibration and benchmarking of measurement methods that systematically quantify gaseous emission of pollutants and ensure that such gaseous calibrations are accurate in the field.

There are multiple monitoring technologies available to validate such pollutants, and there are also multiple methods for the calibration and testing of such systems, but these typically rely on the use of laboratory-specified and designed equipment or non-repeatable, analog, and manually-adjusted calibration techniques. However, accurate and defensible calibration standards are typically exacting to faithfully replicate actual “emission events” and, in part, because alternative commercially scalable options have not yet been identified. What is needed is a computer-controlled calibration approach that can be applied on a routine basis, such as for the routine benchmarking and quality assurance of various gaseous outputs from traditional tank outputs.

In-field gaseous calibrations are carried out by using a pressurized gas tank or cylinder containing a known gas calibration mixture. The gas calibration mixture is designed to contain gas concentrations in the range of what would be seen during operation. One example of a gas calibration mixture is Bar 97 High, which contains set concentrations of hydrocarbons (3189 ppm), carbon monoxide (7.99%), carbon dioxide (12.0%), and nitric oxide (3002 ppm). Each batch of gas mixture is independently and analytically tested by the manufacturer to determine the exact concentration of each pollutant to ensure the accuracy of a calibration.

The delivery of the calibration gas to the measuring device requires the use of one or more gas flow regulators that takes the high pressure of the tank and lowers it substantially so that it can fully saturate the inlet of the measuring device without over-pressurizing the delicate sensors and damaging the equipment. A traditional regulator in the industry requires an operator to trim the flow rate manually by turning a knob that directly changes the size of an orifice that the gas flows through. A more complex multi-stage regulator may be used, which steps down the tank pressure over two regulators and allows more precise control. However, the added control comes at the expense of size, complexity, and weight. With a traditional regulator, the operator must also use an external flow meter or other measuring equipment to independently verify the gas flow rate before each use. In many cases, traditional regulators are connected to each other in series and use multiple adapters to properly control the gas flow. The addition of multiple pressure gauges along the regulator also add to the bulkiness. A traditional gas regulator setup can extend out from the gas tank up to fifteen inches, which causes considerable risk of tripping, damage to the regulator, instability of the tank, etc.

Traditional manual regulators experience creep over time, which is the slight decrease in the tolerance of parts that allow a small amount of gas to flow through when the regulator is supposed to be completely shut. Besides the obvious detrimental effects of toxic gas exposure, this can be especially dangerous in fields when people are working with explosive gases. If there is a slow but steady gas leak from a creeping regulator, and there is some sort of ignition, it can result in physical devastation, injury, or death. Industry is beginning to require a safer and more precise integrated “smart” regulator that allows traditional calibration processes to be completed in a timelier manner while providing the user with verifiable data.

Performing an equipment calibration routine with traditional methods can be time-consuming, inefficient, and dangerous. Between swapping regulators and adapting the regulators to different tanks, the calibration process can take upwards of an hour to set up. Many times, the calibration process is followed by an audit, which is a re-calibration to separately verify the calibration. If the calibration sequence is meant to better replicate real-world emissions, it may also require the use of different gas tanks and other components, in which case the inlets and outlets must be swapped around multiple times during the calibration process. For calibration processes, a programmable, verifiable integrated calibration device is needed to improve and automate device calibration while increasing precision of the calibration process and providing data to the user.

There are also fields, other than emissions, that use precisely-regulated gases in an every-day work environment. These include fields such as chemical research, welding, and medicine. Precisely-regulated gases in these industries can produce the highest yield possible and maintain chemical stability, ensure integrity of a weld, and administer proper amounts of anesthetics or oxygen, respectively. In these industries, getting the correct amount of flow in the shortest time possible can be important (e.g., if a patient is in critical condition and needs to be anaesthetized for an immediate operation). Manually adjusting a regulator slows operations because manual adjustments on most traditional regulators can take up to one minute. To manually set up the proper flow rate, ensure that there are no leaks, and validate the accuracy of the regulators readout can take upwards of a few minutes. Additionally, there is often no verification that the regulator has not crept or slowly come out of adjustment over time during use. An integrated “smart” regulator where the flow can be automatically adjusted and verified can allow more time to be spent on the main task.

Therefore, an improved gas delivery and/or calibration system is needed.

### BRIEF SUMMARY OF THE DISCLOSURE

A system is provided in a first embodiment. The system includes a base unit and a control unit. The base unit defines one or more inlets and an outlet. The base unit includes at least one valve configured to control gas flow through the base unit from one of the inlets to the outlet. The control unit is configured to be detachably connected to the base unit. The control unit includes a battery, a processor, and a wireless communication unit. The system is configured to generate a controlled distribution of a fluid using the processor of the control unit and the valve of the base unit.

The base unit can include at least one of a mass flow meter, a manometer, a temperature sensor, or a humidity sensor.

The base unit can include at least three of the valves.

The base unit can include an interlocking mechanism. The control unit can be configured to connect with the interlocking mechanism of the base unit.

The base unit can further include an imaging system.

The control unit can further include an RFID reader.

The inlet can be configured to connect to a gas tank or a gas canister.

The control unit can be configured to transmit data regarding an operation of the base unit, a gas flow through the base unit, and/or information regarding a gas tank or a gas canister connected to the inlet.

The processor can be configured to receive data regarding the operation of the system.

The control unit can be configured for duplex communication.

The valve of the base unit can be configured to remain closed when the control unit is disconnected from the base unit.

In an instance, the base unit has at least three inlets in fluid communication with only one outlet.

A method is provided in a second embodiment. The method includes connecting an inlet of a base unit to a gas tank or a gas canister. The base unit includes at least one valve. The base unit is connected to a control unit such that a processor in the control unit is in electronic communication with the valve. A controlled distribution of a fluid is generated using the processor of the control unit and the valve of the base unit.

In an instance, the method includes connecting a second inlet of the base unit to a filter and connecting a third inlet of the base unit to a particulate calibrator-generator configured to vaporize a liquid mixture to generate a particle distribution. In yet another instance, the method includes connecting an outlet of the base unit to an emissions measurement system and measuring particulate matter/number, nitric oxide, nitrogen dioxide, carbon monoxide, carbon dioxide, hydrocarbons, and/or oxygen of the fluid using the emissions measurement system.

The method can include diluting the fluid from the gas tank using the base unit.

The method can include sending instructions to the processor via wireless communications.

The method can include performing a calibration sequence using the processor.

The method can include controlling flow of the fluid using the valve and the processor.

In an instance, the valve of the base unit is closed prior to connecting the base unit to the control unit.

### DESCRIPTION OF THE DRAWINGS

For a fuller understanding of the nature and objects of the disclosure, reference should be made to the following detailed description taken in conjunction with the accompanying drawings, in which:

FIG. 1 includes multiple schematic representations of the Digital Integrated System for Calibration (DISC) device in situ with a standard industrial gaseous calibration tank in accordance with an embodiment of the present disclosure, wherein A is top view, B is a front perspective view, C is a front view, and D is a side view;

FIG. 2 includes multiple schematic representations of the DISC device in accordance with an embodiment of the present disclosure, wherein A is top view, B is a front perspective view, C is a front view, and D is a side view:

FIG. 3 is a three-dimensional exploded view of the DISC device separated into the control unit, base unit, and optional gas tank adapter in accordance with an embodiment of the present disclosure:

FIG. 4 is an internal representation of the control unit in accordance with an embodiment of the present disclosure:

FIGS. 5-8 are diagrams showing the possible computer-controlled flow paths inside of the base unit:

FIG. 9 is a representation of the duplex communication between the DISC and an electronic device; and

FIG. 10 is an embodiment of an implementation of the DISC for a calibration routine.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

This disclosure relates to a gas delivery and/or calibration system and a two-way (e.g., duplexed) regulator device, with the ability to more accurately and precisely control a predictable and repeatable calibration routine. The disclosed apparatus and method electronically control a gaseous fluid flow for precise gas delivery and calibration. The apparatus and method embodiments disclosed herein increase the repeatability, safety, and reliability of traditional gaseous calibration methods by employing absolute on-off flow control valves, digital flow regulators, and duplex communication with the user. The disclosed embodiments also reduce the time required to perform a standard calibration routine by employing multiple inlets, a single control device, and the ability to pre-program calibration sequences. Simultaneous control of, for example, the outlet from a particle generator-calibrator and calibration gas is enabled, which allows particle generator-calibrator to better represent the actual emission events associated with vehicle engines, stationary exhaust stacks, etc.

An apparatus for controlling a gaseous fluid flow and a computer-controlled calibration routine to mimic vehicle emissions are provided in an embodiment. The apparatus, also known as the Digital Integrated System for Calibration (DISC), overcomes many of the problems of manual gaseous tank calibration. The DISC device can be used to generate a controlled, predictable, reproducible, and variable pressure distribution of a digitally-controlled gas output using designated pathways indicated by a digitally-controlled input with a computer-controlled ability to perform a user-designated set of calibration routines.

The DISC comprises of a base unit and a control unit (a Detachable Electronic Controller (DEC)), which are connectable through a mechanical locking mechanism that simultaneously provides a sealed electronics contact. The base unit can include a housing having one or more inlets: an outlet: one or more normally closed on-off flow control valves: a two-way flow control valve: an on-demand flow regulator, one or more digital flow regulators: one or more one-directional valves; and one or more sensors to measure at least one of pressure, flow, temperature, or humidity. The components of the base unit are connected fluidically with one or more flow tubes. The digital regulators can be configured to provide a variable fluid flow rate.

The base unit can have different dimensions and/or configurations for different tanks or applications. The base unit's connection to the tank or gas canister can depend on the size of the tank/gas canister or the type of valve used by the tank/gas canister. Thus, the DISC can be used with a variety of different tanks/gas canisters. The base unit can be configured to adapt to multiple different tanks/gas canisters or can be configured to only connect with a single type of tank/gas canister. If the base unit only connects with a single type of tank/gas canister, then a separate adapter can be used for different tanks/gas canisters.

The flow control valves and flow tubes can have the same diameter or different diameters. The base unit can further include three normally closed on-off flow control valves. Each flow control valve is disposed on a separate inlet of the base unit. A two-way flow control valve may be disposed on a flow tube to direct the flow into one of two other flow tubes. Using a combination of the flow control valves, flow tubes, and digital flow regulators, the flow of gas from the tank can be precisely controlled. The various flow tubes can connect to a pathway out of the base unit. The properties of the fluid flow can be measured by sensors included as part of the flow pathway. One or more flow paths may contain a mechanical over-pressure relief valve to additionally protect connected equipment. The base unit may include an electronically controlled vent to relieve pressure in the flow paths after use.

The sensor data may be provided to the user and/or be used as part of a feedback control system. In the feedback control system, the device may be “smart” by automatically adjusting and fine-tuning the digital flow regulator to maintain the specified flow rate. For example, the digital flow regulator can automatically shut off after a designated period of time, can be remotely controlled and/or monitored (e.g., with a camera or sensor readings), and can provide notifications for various events (e.g., error, task complete, or calibration complete). The digital flow regulator can operate wirelessly.

A combination of electronically controlled flow control valves and digital flow regulators can provide a more accurate, reliable, and consistent result than a human operator attempting to reproduce an exact setting with a manually-controlled valve configuration on traditional regulator equipment. One or more flow control valves may be opened at the same time depending on the configuration of the DISC in a system.

The control unit can include a housing having an electronics sub-system. The electronics sub-system can include a rechargeable power source: a processor, a power board: a wireless or wired communications component (e.g., Bluetooth); and a voltage-to-digital converter. The operation of the gas flow sequence can be programmable.

The electronics sub-system can be configured to control the base unit including the flow control valves and digital regulators. The electronics sub-system also can receive sensor measurements from the base unit when mechanically and electronically connected. In an instance, the electronics sub-system can be remotely configured to control the flow control valves and digital regulators. In an instance, the electronics sub-system can be turned on and off by a physical switch on the device and/or through a wireless connection.

The rechargeable power source can be charged using, for example, a USB or barrel jack charger. The rechargeable power source can be in electronic communication with the base unit that includes flow control valves, digital regulators, and associated electronics such as wires or power distribution boards. The rechargeable power source can also be charged using, for example, a docking station for the control unit.

The control unit can be configured to be powered via wall power by either continuously charging the rechargeable power source or by using a separate electronic circuit with, for example, an electronic relay that switches the power source between wall power and the rechargeable power source.

A camera and/or an RFID reader can be included on the control unit or base unit to read, identify, and/or inspect a scan label on the gaseous tank. The camera and/or RFID reader can be used to identify tank contents. The camera can allow a remote operator to view and/or record aspects of the setup, calibrator, or gas transfer to ensure proper operations. The control unit also can include a GPS unit to determine the location of the tank.

The control unit can include a manual knob (i.e., potentiometer) or switches that can be used to control the flow with the control unit without connection between the control unit and a wireless device.

The control unit can include a speaker to relay information to the user. In an example, the device may use the speaker to warn the user that the gas tank is almost empty. Other alerts, warnings, or instructions are possible.

The control unit or base unit also can include one or more analog pressure displays for the flow.

Duplex communication between the user and the DISC is possible. Duplex communication can allow a remote/wireless operator and/or computerized program to monitor the activities of the calibration events and to act based on incoming information by sending commands directly to the control unit that controls the flow and controller hardware. The duplex communication configuration can provide an ability to ensure safety, security, and quick response, while reducing wasted tank resources, operator time, repeats of failed calibrations, and/or events, etc.

The embodiments of the system disclosed herein can be used for calibration of an electronic device to ensure the electronic device is operating at a standard. This can be achieved by controlling an amount of gas flowing from a gaseous tank with a known gaseous concentration amount into the electronic device and ensuring the electronic device sensors are reading the concentration output of the gaseous tank.

In an instance, the gas is supplied through one of three device inlets. The inlet may be connected directly to a gas cylinder or connected fluidically by an adapter or length of tubing or conduit. The gas flow is electronically directed through one or more flow paths depending on the intended usage of the device. The flow paths can include a pressurized on-demand flow path, a pressurized regulated flow path, a low-pressure regulated flow path, and a bypass flow path. The active flow path may be based on the consistency of the fluid, the pressure of the fluid, and the desired type of flow control, if any. One or more flow paths may be used simultaneously to create mixtures or dilutions, for example. The individual flow paths join inside the device before exiting through the device outlet. Additional feedbacks on conditions during the gas delivery process can be provided by in-line sensor(s).

A normally closed on-off flow valve is described as an electronically controlled gate that can be either on (open) or off (closed). For example, the physical gate may be in the form of a plunger or door. The valve is configured such that if there is no electrical power to the valve, then it is in the off (closed) state. In the off (closed) state, the valve provides a leak-free seal. Electrical power can be sent to the valve for it to enter the on (open) state.

A two-way valve is described as a valve in which a single inlet can be switched to one of two possible outlets electronically.

An on-demand flow regulator is described as a component that mechanically controls a fluid flow based on the flow rate of a connected downstream pump. The on-demand flow regulator adjusts to provides the same flow rate as that of the connected downstream pump. For example, if a connected downstream pump has a flow rate of 3.0 liters per minute, then the on-demand flow regulator can provide a flow rate of 3.0 liters per minute. If no downstream pump is connected or the downstream pump is off, then the on-demand flow regulator provides a leak-free seal.

A digital flow regulator is described as a component that allows the fluid flow rate to be controlled electronically. Generally, the fluid flow rate may be controlled by means of a variable size orifice. The orifice may be shaped to better control the gas and produce a more controllable and precise flow rate. Converting an electrical signal into a physical change of the orifice size may include the use of a stepper motor with lead screw or ball screw, a linear actuator, rotating cam, etc. Since the flow regulator can be controlled digitally, a downstream flow meter or other sensors can provide feedback data such that the flow regulator may automatically fine-tune the orifice size to maintain the specified flow rate over time and provide more precise, accurate, repeatable flow distributions.

The base unit and the control unit can be connectable through a mechanical locking mechanism which provides a sealed electronics contact for communication between the two components. In an embodiment, the base unit includes a housing having three inlets; an outlet; three normally closed on-off flow control valves; a two-way flow control valve; an on-demand flow regulator, two digital flow regulators; one or more one-directional valves; and one or more sensors to measure at least one of pressure, flow rate, temperature, or humidity. The components of the base unit can be connected fluidically with one or more flow tubes. The digital regulators can be configured to provide a variable fluid flow rate.

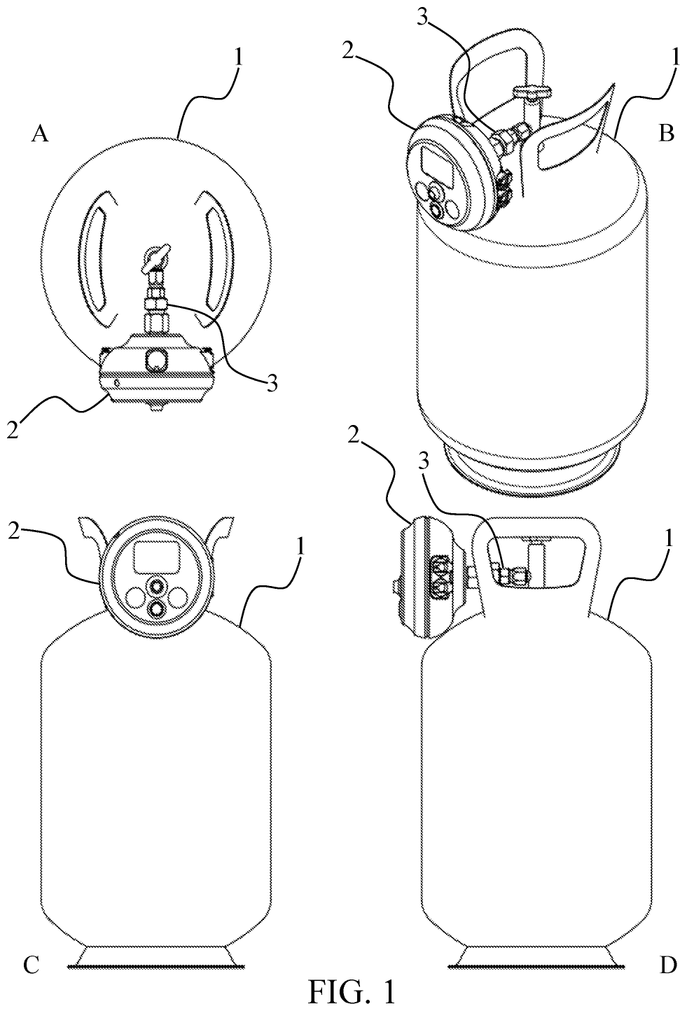

FIG. 1 illustrates the interaction of the DISC 2 with a fluid source 1 (e.g., a gas calibration tank or canister), connected via an appropriate tank adapter 3. The DISC 2 can electronically connect relevant data from the source of the calibration gas (e.g., the fluid source 1) and wirelessly communicate the information to the testing device and/or end user, while allowing the end-user and/or an automated computer program to control aspects of calibration test (e.g., gaseous amount, time length, test date, test time, test location, pressure, temperature, safety/security conditions, etc.) and providing a digitally accurate, mass-repeatable calibration and/or gaseous program, and control of systems operation. The data can include flow properties, pressure, temperature, gas mixture and type, amount of gas, time remaining, physical location, and/or operator information.

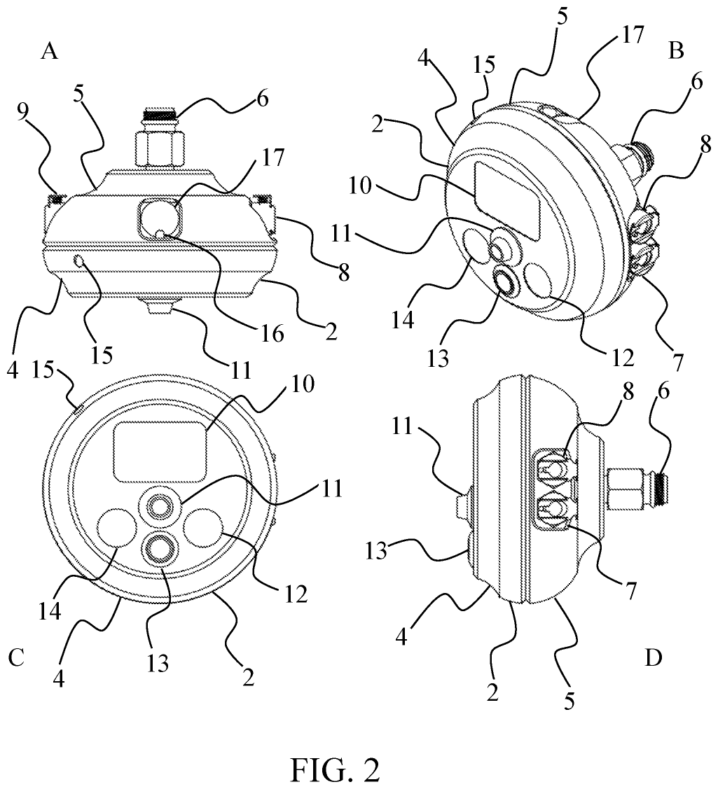

FIG. 2 illustrates the DISC 2 exterior which comprises inlets 6-8; an outlet 9; an imaging system (e.g., camera) 16; one or more digital displays 10 and 12; a manual knob 11; a power button 13; a speaker 14; and a charging port 15. While inlets 6-8 are illustrated, more or fewer inlets are possible. The DISC 2 is separable into a base unit 5 and a control unit 4. The control unit 4 also can be referred to as a Detachable Electronic Controller (DEC). Generally, the base unit 5 includes various flow control devices and flow paths. The control unit 4 contains an electronics sub-system that can control the base unit 5 and can receive data from the base unit 5 when the control unit 4 and base unit 5 are connected. The imaging system 16 can be used to scan barcodes, QR codes, or other identification tags. The imaging system 16 also can be used to monitor the device's behavior, use, and/or operation. The manual knob 11 can be used to adjust the flow rate on one of the two adjustable flow paths. This can allow the DISC 2 to be controlled without connection to a computer. For example, in a welding environment, using a computer to adjust the flow rate may not be desired at certain times during operation. The manual knob 11 may be beneficial when adjustment to a computer may be too slow or complicated.

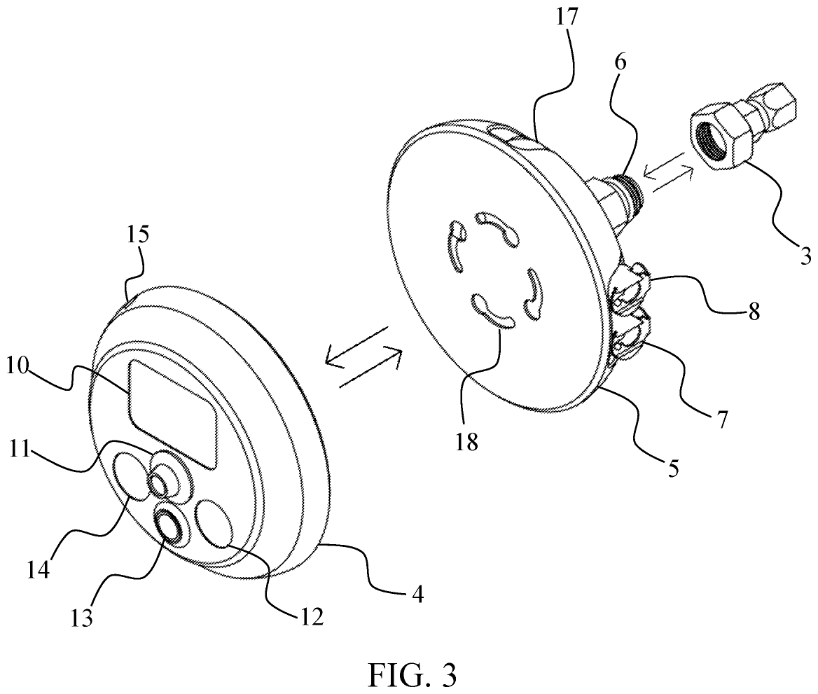

FIG. 3 is a three-dimensional view illustrating the control unit 4 disposed on the base unit 5 using a quick-connect mechanical lock mechanism 18 that provides a physical connection and a sealed electronics contact. The sealed electronics contact can provide an electronic handshake between the base unit and the control unit which can use encrypted software to transfer (e.g., simultaneously) outgoing data from a gas tank and incoming data from a wireless/remote device and/or computer program. FIG. 3 also shows an example of an optional gas tank adapter 3 that can be used with the base unit 5 to allow it to connect to different gas tank valves.

The sealed electronics contact in the mechanical lock mechanism 18 can use mechanical lock pegs to complete a circuit. When two parts are connected, the control unit 4 and the circuit board with the receiving pads can rotate to lock. The pegs can be individually surrounded by rubber, a polymer, a sealant, an adhesive, or another material. In an instance, rubber grommets, o-rings, and/or contact pins or pads encased in rubber are used for the contact. The mechanical lock mechanism 18 also can be or also can include a friction fitting or magnetic lock.

If the control unit 4 is disconnected from the base unit 5, the base unit 5 can be locked out as a safety feature. The base unit 5 includes normally closed on-off flow valves that prevent any gas flow out of the cylinder when battery power is lost and/or the control unit is removed. The base unit 5 may not operate or enable gas flow without connection to the control unit 4. Thus, removal of the control unit 4 can prevent the base unit 5 from allowing any gas flow: This can serve as a lock out/tag out function. The flow valves in the base unit 5 can be solenoid valves, but other valves (e.g., ball valves) are possible.

The mechanical lock mechanism 18 between the control unit 4 and base unit 5 can be a mechanical lock with a circuit security mechanism. Using the mechanical lock mechanism 18, one control unit 4 can be used with multiple different base units 5, even if the base units 5 are different shapes or sizes. The interlocking mechanism 18 includes an electronic connection for data transfer and/or power between the control unit 4 and base unit 5. Fluids can be isolated in the base unit 5, such as within tubing. The fluids may not contact the control unit 4. Thus, the control unit 4 can contain electronics while the base unit 5 can include pneumatics, electronics, or other devices to operate valves.

The interlocking mechanism 18 can be configured such that the orientation of the control unit 4 to the base unit 5 can be changed depending on how the control unit 4 is installed. For example, the interlocking mechanism 18 can make the control unit 4 display more readable. Thus, the DISC 2 can be operated in multiple orientations.

In an instance, the mechanical lock has four-way symmetry. Therefore, the control unit 4 can be installed at 0°, 90°, 180°, or 270° relative to a point. A 90° counter-clockwise turn can lock the control unit 4 to the base unit 5. Of course, a clockwise turn or other degrees of rotation or installation are possible. For example, if a 0° positioned is desired for the control unit 4, the control unit 4 can be inserted at 90° then rotated 90° counter-clockwise to lock the control unit 4 at 0°. The electronic connection can be at the center of the control unit 4 to enable the connections. This can enable a user to read the control unit 4 in different situations or storage spaces.

The connection between the control unit 4 and the base unit 5 can include sensors or other electronic connections besides a physical connection and/or lock. For example, a sensor may be used by the device to confirm to the user that the control unit 4 and the base unit 5 are connected.

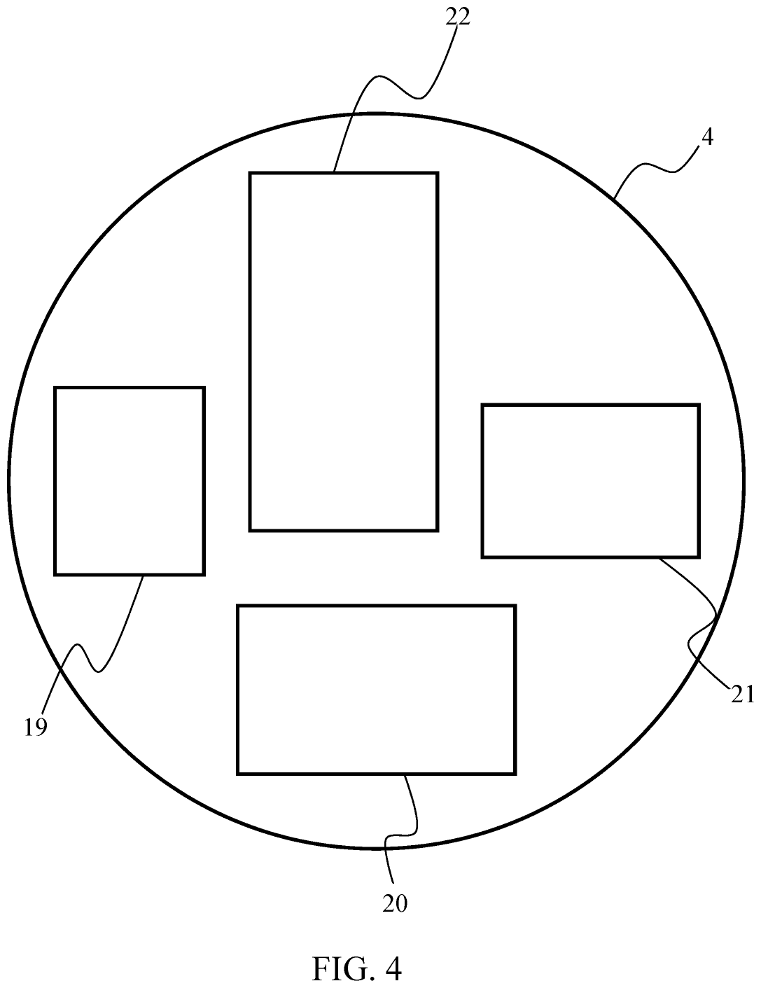

FIG. 4 is an internal representation of the control unit 4. The control unit 4 includes a housing having an electronics sub-system. The electronics sub-system can include a rechargeable power source 19, a processor 20, a power board 21, and a wireless or wired communications component (e.g., Bluetooth) 22. A storage medium also can be included as part of the control unit 4. Thus, the operation of the gas flow sequence can be programmable.

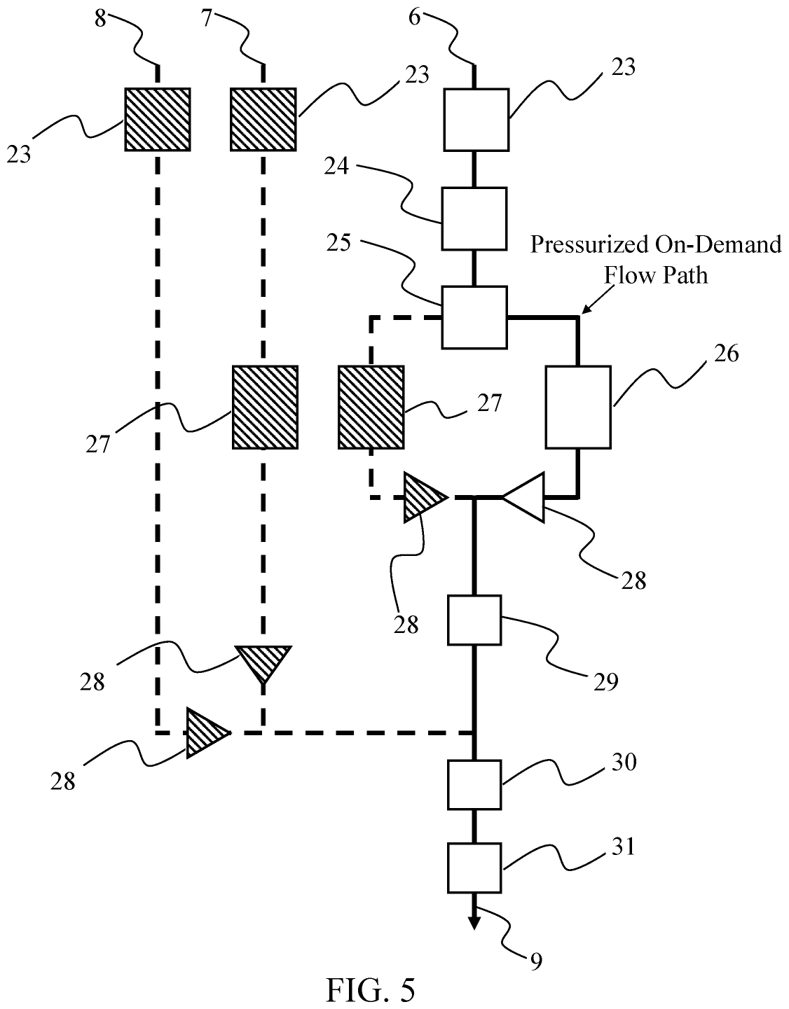

FIGS. 5-8 are representations of the different fluid flow paths inside of the base unit 5. The base component 5 includes multiple inlets 6-8 in an embodiment, though more or fewer inlets are possible. One or more of the inlets may be used simultaneously depending on the DISC configuration or required calibration sequence. In FIGS. 5-8, the flow path followed by the fluid is shown with a solid line, whereas blocked flow paths are shown with dotted lines.

FIG. 5 is an example of a pressurized on-demand flow path. This is a gas flow path when the DISC is used with a pressurized gas tank and an on-demand flow regulation is desired. The corresponding inlet 6 of the DISC is connected to an outlet of the gas tank. For example, the inlet 6 may screw or quick-lock connect to an outlet of the gas tank, providing a leak-free seal. An adapter 3 may be used to allow attachment to different gas tanks, or the base unit may be different for different gas tank valves. In an example, the control unit controls the flow valves 23 such that the pressurized flow path valve is open but the other two are closed. This forces the pressurized gas to flow through the pressurized flow path, which may include an inlet pressure manometer 24. The inlet pressure manometer 24 measurement may be displayed on the DISC digitally with the display 10 or with an analog display 17. The display 10 can be a digital display on the control unit 4 that may include test parameters, time, date, sensor measurements, gas type, etc. Display 17 may be an analog dial gauge that displays the pressure of the connected tank.

The sensor reading may also be transmitted to the user using a wireless connection (e.g., Bluetooth). The pressurized flow path contains a two-way valve 25 that is electronically controlled to force the flow into either the on-demand flow regulator 26 or the digital flow regulator 27 flow path based on the input to the electronic system. The input may be from a user using an electronic device or from a programmed calibration sequence. The flow paths may also include one or more one-directional valves 28 to prevent backflow of the fluid.

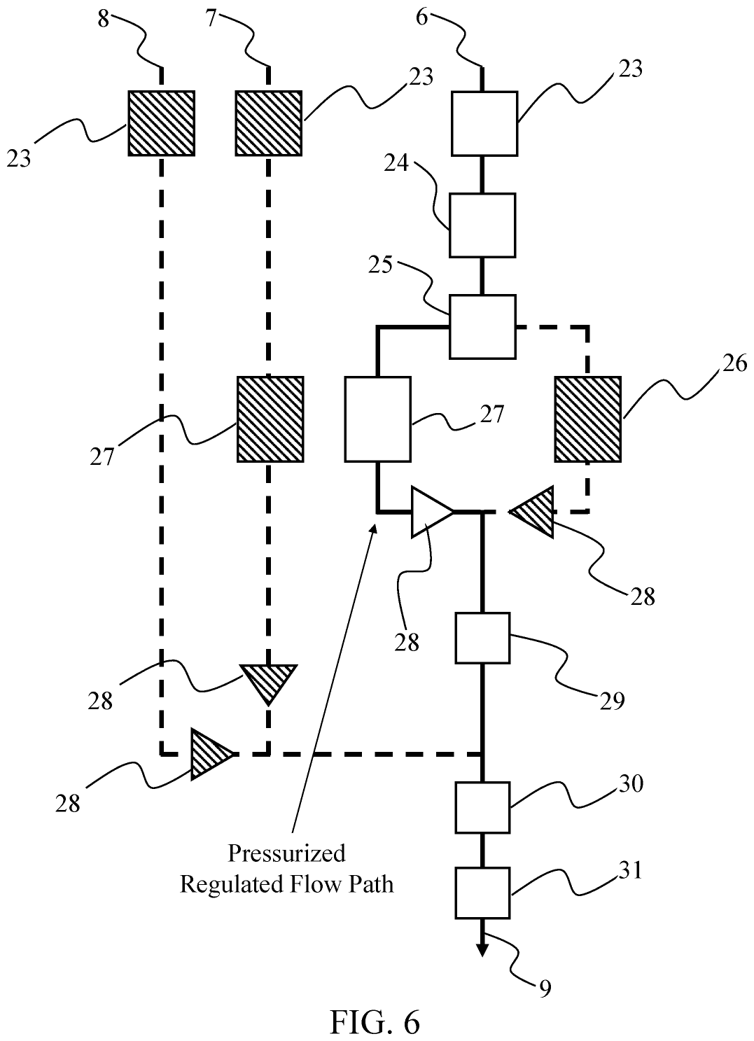

FIG. 6 is an example of a pressurized regulated flow path. This is the fluid flow path when the DISC is used with a pressurized gas tank and specific, precise flow regulation is desired. The flow path may utilize the same inlet 6 as the pressurized on-demand flow path in FIG. 5. The flow path in FIG. 6 uses a digital flow regulator 27 to electronically control the flow rate of the fluid. The pressurized flow path may rejoin after the digital flow regulator 27 and the flow path may include a delivery pressure manometer 29, a flow meter 30, or other sensors 31 (e.g., temperature or humidity sensors) before exiting the base unit at a single outlet 9. The sensor data may be displayed on the device and/or sent to the user using a wireless connection (e.g., Bluetooth or Wi-Fi transmission). Additionally, the digital flow regulator 27 may utilize a smart feedback system. The smart feedback system utilizes data from the downstream sensors 29-31 (e.g., flow rate) to change the flow automatically and electronically for greater precision, accuracy, and reliability. In an example, the smart feedback system can correct regulator drift over time, which is common with traditional equipment. The digital flow regulator can be calibrated periodically or tuned using an external high precision device to ensure precision over time. For example, a flow meter at the end of one or more pathways of the DISC can be used. The flow path may additionally include an electronically controlled vent to release excess pressure in the flow tubes after use as an added safety measure. The flow path may also include an over-pressure relief valve to further protect connected equipment.

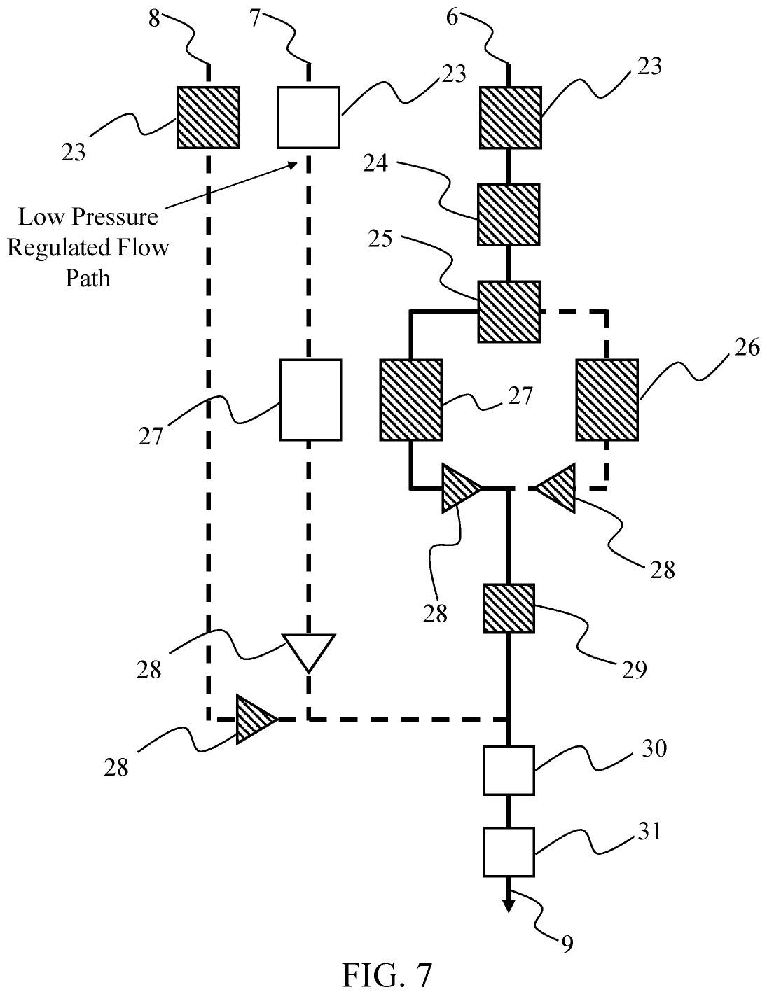

FIG. 7 is an example of the low pressure regulated flow path. This flow path comprises an inlet 7, a normally closed on-off flow control valve 23, a digital flow regulator 27, and a one-directional valve 28. Two of three flow control valves 23 are in the closed position, forcing the fluid through the only remaining flow path. In an example, this flow path may be used with low-pressure fluids, such as if a diaphragm pump or water pump is upstream of the inlet. This flow path may also be used with the digital flow regulator 27 in an “open” state where the flow rate from the upstream pump is less than the maximum controllable flow rate of the digital flow regulator. In an example, the fluid would be able to flow through this flow path unaltered if desired. This flow path may be used with various media including gases, mixtures, liquids, and slurries. This flow path may rejoin the other flow paths inside the base unit to meet at one outlet 9. The flow path may also include one or more sensors 30 and 31.

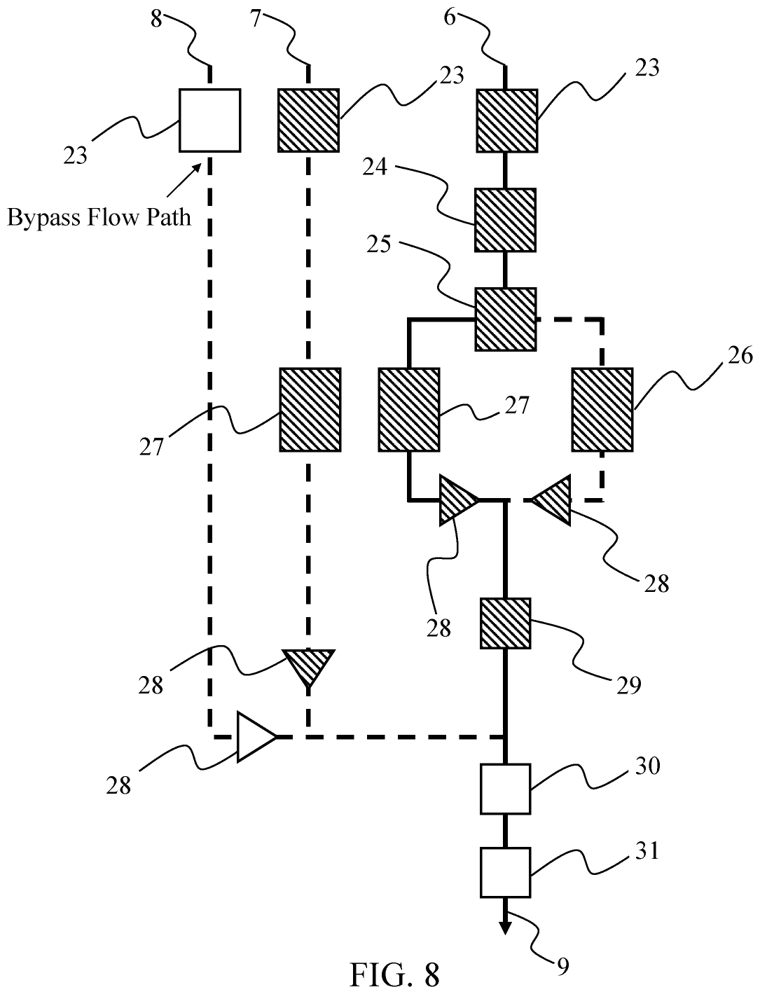

FIG. 8 is an example of the bypass flow path that includes a normally closed on-off flow control valve 23 and a one-directional valve 28. Two of three flow control valves 23 are in the closed position, forcing the fluid through the only remaining flow path. The bypass flow path rejoins the other flow paths before exiting the base unit through the outlet 9. This flow path allows a fluid to flow through the device unaltered. Typically, this flow path would be used in conjunction with one or more of the other flow paths, but it may also be used alone in order to get an electronic on/off control of the flow with flow control valve 23 or to measure characteristics of the flow using the flow meter 30 or other sensors 31 that may be included in the base unit. In an example, the bypass flow path may be used with a high-efficiency particulate air (HEPA) filter upstream to add a purge or zeroing cycle to a calibration sequence.

The inlet is in fluid communication with multiple flow control valves or mechanical apertures. Four valves are illustrated in FIGS. 5-8, but more or fewer valves are possible. For example, from one to fifty gates or apertures can be included in the base unit with corresponding tubing. Tubing or a pneumatic system can form the connections. Sensors (e.g., a flow meter, pressure manometer, temperature sensor, or humidity sensor) can measure properties of the fluid flow through the base unit. The outlet is in fluid communication with the tubing or pneumatic system. The flow control valves can be configured to operate based on an on-off input from a user, wireless device, run on a timer, or as part of a programmed calibration sequence.

A battery, processor, or electronics sub-system can be included in the housing of the base unit, which can control physical aspects of the gas via the valves and/or aperture systems, as well as direct communication with the connected control unit. It may also be used to power electronic components mounted on the base unit such as a camera. The control unit can provide the full duplexing communication capabilities, wireless functionality, and/or camera, and can be the “key” to the “lock-and-key” electronic security feature.

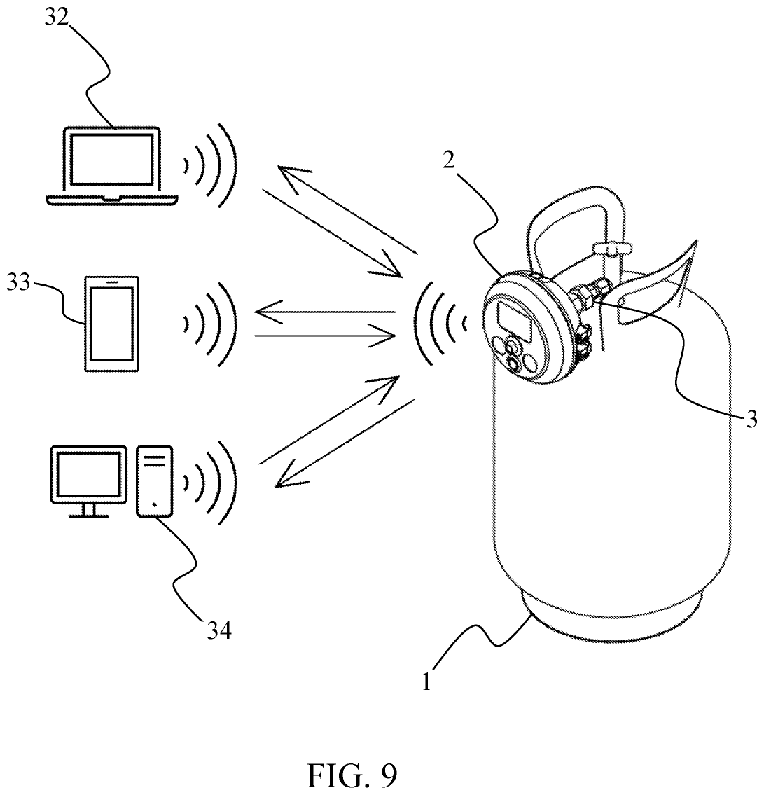

As shown in FIG. 9, the DISC 2 can have one-way or two-way communication with various devices, such as a laptop 32, smart phone 33, or desktop computer 34. These devices can control operation of the gas flow and can monitor status of the operation or other gas flow data.

The DISC 2 has built-in compatibility with other devices that measure particulates, gases, and liquids. With its three-channel design, the DISC 2 is able to condense these three dissimilar types of input into a singular output that can connect to any device even if it only has one input (compared to a device that has a separate port for calibration gases and one for the sample). In an example, the DISC 2 may be used with a single-inlet emissions measuring device to create three inlets: a calibration gas inlet, a sample inlet, and a HEPA pathway for zeroing or purging.

In an example, a user may choose to dilute a gas going into a downstream device with an onboard pump using the DISC 2. Referring to FIGS. 2 and 9, a pressurized gas cylinder 1 is connected to the pressurized flow path inlet 6 in this configuration and uses the pressurized regulated flow path. The user sets a dilution ratio (i.e., using a connected wireless device and computer program or application) and the digital flow regulator 27 adjusts to allow the correct flow through the pressurized flow path. Simultaneously, a flow control valve 23 controlling the bypass flow path inlet 8 opens electronically and the dilution air may flow through the bypass flow path before joining the pressurized flow path and exiting the base unit through the outlet 9. In an example, the device with the pump has a flow rate of 6.0 liters per minute (LPM), which may be measured by the DISC onboard flow meter 30 (shown in FIGS. 5-8). If a gas-to-air ratio of 2:1 is desired, the digital flow regulator 27 electronically opens to allow 4.0 LPM of gas through. The remaining 2.0 LPM is air pulled through the bypass flow path. The result is a precisely diluted gas mixture (e.g., ±5% error from a set value). In an example, the bypass flow path may include an upstream HEPA filter to filter the dilution air.

Precision can be determined by the precision of the digital flow regulator (e.g., 2-3 decimal place precision). The speed to turn on and off can be based on the valves. The valves can include normally closed on/off valves, check valves, and a two-way valve on the pressurized inlet pathway. In an instance, the on/off valves can be solenoid valves that can open and close in 200 microseconds.

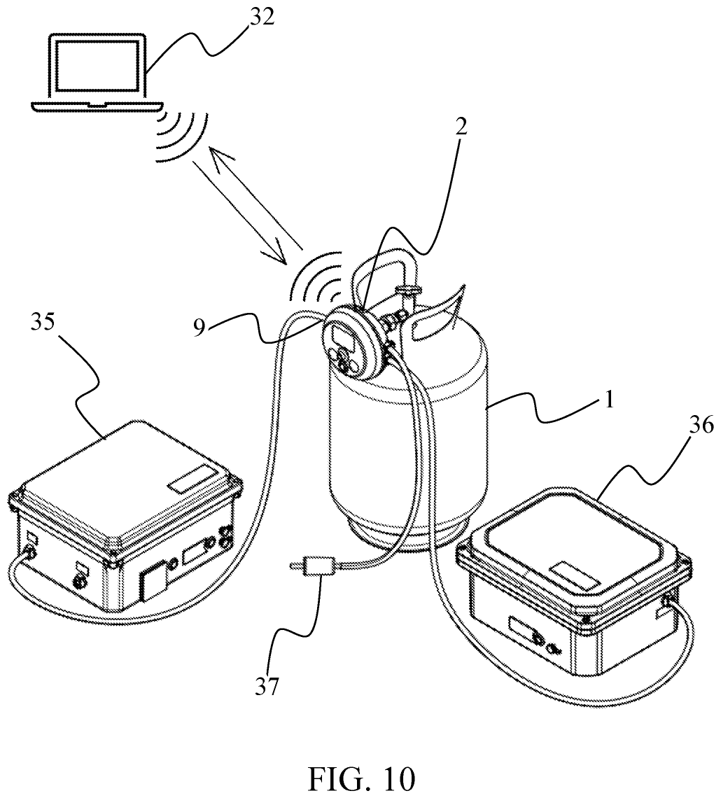

FIG. 10 is an embodiment of an implementation of the DISC 2. The pressurized gas cylinder 1 can be fluidically connected with a device to be calibrated, such as emissions measurement system 35 like a PARSYNC IPEMS (integrated portable emissions measurement system) device manufactured by 3DATX Corporation, using the DISC 2 pressurized flow path inlet 6 and outlet 9. The PARSYNC is a portable system that can measure particulate matter/number, nitric oxide, nitrogen dioxide, carbon monoxide, carbon dioxide, hydrocarbons, and/or oxygen. Other IPEMS devices also can be used. At the same time, the DISC device can be fluidically connected with a particle generator, such as a CAGE (calibrator-generator) 36, manufactured by 3DATX Corporation, using the low-pressure regulated flow path inlet 7. The CAGE is a particulate calibrator-generator that utilizes a heater coil atomizer to vaporize liquid mixtures to generate a controlled, repeatable, and variable particle distribution. Other particulate generator systems and/or particulate calibrators also can be used. Additionally, a high-efficiency particulate air (HEPA) filter 37 may be fluidically connected to the bypass flow path inlet 8 of the DISC 2. In this configuration, the DISC device 2 can provide a controlled and systematic ability for rapid and accurate calibration of field equipment by eliminating steps typically provided by a human operator. The calibration sequence can include controlled periods of calibration gas, particulates, and filtered HEPA air for zeroing or purging the system. Since the user may only connect the device to be calibrated to the DISC outlet 9, this can further reduce the time required to calibrate a field device, which allows field equipment to be much more rapidly put back into service after a required calibration is performed. This can be especially valuable when calibrating a fleet of equipment that requires the same calibration setup for each piece of equipment. Additionally, it can ensure that the entity requiring such calibrations have a reliable, predictable, and accurate calibration/record of such events. In an example, the DISC 2 can create a much more comparable vehicle emissions sample by simultaneously outputting gases and particulates to the device to be calibrated.

In an example, gas is passed through the DISC 2 via one of the channels and it cleans that channel and output of the DISC 2 as it passes through. The channel depends on depending on if the gas is pressurized zero gas or if it is ambient, filtered air. In an example, the calibration sequence can include the following steps: 1) 2 minutes of filtered HEPA air (purge), 2) 1 minute of filtered HEPA air (zero): 3) 1 minute of Bar 97 High Gas mixture (calibrate and adjust NO, CO, CO₂, HC): 4) 2 minutes of filtered HEPA air (purge): 5) one particle distribution (i.e., consisting of 1 million particles between 10-40 nanometers to calibrate and adjust particulate sensors); and 6) 2 minutes of filtered HEPA air (purge). This process can be repeated to perform an audit and verify all adjustments were properly updated. The Bar 97 High Gas can be provided by the pressurized gas cylinder 1. The HEPA air can be provided by the HEPA filter 37. The particles can be provided by the CAGE 36. Measurements can be made by the emissions measurement system 35. For purge and zero, the DISC 2 uses the bypass flow path. For the calibration gas, the DISC 2 uses the pressurized flow path. For the particulates, the DISC 2 uses the low-pressure regulated flow path. With a connected computer, a user can set time of each period and change the order. The user can press a button to start calibration and the DISC 2 can automatically run through the steps by opening and closing the required valves.

Calibration data, such as the sequence or gas flow characteristics, can be wirelessly transmitted to the computer that is connected to the DISC 2, which is transmitting the specific pressure and pathway needed for the task. The calibration data can be embedded into the ongoing test data, a testing event, or electronics usage file. The calibration data can be programmed as part of the electronics sub-system.

Data from calibration or operation can be transferred to a data file by the DISC 2.

The systems and the sub-systems therein can include a personal computer system, mainframe computer system, smart phone, tablet, workstation, network appliance, internet appliance, or other device. The sub-system(s) or system(s) may also include any suitable processor known in the art, such as a parallel processor. In addition, the sub-system(s) or system(s) may include a platform with high-speed processing and software, either as a standalone or a networked tool.

In some embodiments, various steps, functions, and/or operations of systems and the sub-systems therein and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link. For instance, the various steps described throughout the present disclosure may be carried out by a single processor (or computer system) or, alternatively, multiple process (or multiple computer systems). Moreover, different sub-systems of the systems may include one or more computing or logic systems. Therefore, the above description should not be interpreted as a limitation on the present disclosure but merely an illustration.

While disclosed with respect to emissions testing, the embodiments disclosed herein can be used in many industries. For example, embodiments disclosed herein can be used with automotive, medical, chemical research, manufacturing, clean room (e.g., semiconductor manufacturing), or other applications where precision gas flows are used. This can be helpful in situations where precise doses are needed and doses are monitored (e.g., medical applications) or in situations where remote operation can be beneficial (e.g., a clean room application). Not all these applications are for calibration purposes. For example, the gas flow can be controlled in a manufacturing or treatment setting. Furthermore, while disclosed with respect to gases, the DISC device can be used with mixtures, liquids, slurries, or other fluids.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a base unit that defines one or more inlets and an outlet, wherein the base unit includes at least one valve configured to control gas flow through the base unit from one of the inlets to the outlet; and
a control unit that is configured to be detachably connected to the base unit, wherein the control unit includes a battery, a processor, and a wireless communication unit, wherein the system is configured to generate a controlled distribution of a fluid using the processor of the control unit and the valve of the base unit.

2. The system of claim 1, wherein the base unit includes at least one of a mass flow meter, a manometer, a temperature sensor, or a humidity sensor.

3. The system of claim 1, wherein the base unit includes at least three of the valves.

4. The system of claim 1, wherein the base unit includes an interlocking mechanism, and wherein the control unit is configured to connect with the interlocking mechanism of the base unit.

5. The system of claim 1, wherein the base unit further includes an imaging system.

6. The system of claim 1, wherein the control unit further includes an RFID reader.

7. The system of claim 1, wherein the inlet is configured to connect to a gas tank or a gas canister.

8. The system of claim 1, wherein the control unit is configured to transmit data regarding an operation of the base unit, a gas flow through the base unit, and/or information regarding a gas tank or a gas canister connected to the inlet.

9. The system of claim 1, wherein the processor is configured to receive data regarding the operation of the system.

10. The system of claim 1, wherein the control unit is configured for duplex communication.

11. The system of claim 1, wherein the valve of the base unit is configured to remain closed when the control unit is disconnected from the base unit.

12. The system of claim 1, wherein the base unit has at least three inlets in fluid communication with only one outlet.

13. A method comprising:
connecting an inlet of a base unit to a gas tank or a gas canister, wherein the base unit includes at least one valve:
connecting the base unit to a control unit such that a processor in the control unit is in electronic communication with the valve; and
generating a controlled distribution of a fluid using the processor of the control unit and the valve of the base unit.

14. The method of claim 13, further comprising:
connecting a second inlet of the base unit to a filter; and
connecting a third inlet of the base unit to a particulate calibrator-generator configured to vaporize a liquid mixture to generate a particle distribution.

15. The method of claim 14, further comprising:
connecting an outlet of the base unit to an emissions measurement system; and
measuring particulate matter/number, nitric oxide, nitrogen dioxide, carbon monoxide, carbon dioxide, hydrocarbons, and/or oxygen of the fluid using the emissions measurement system.

16. The method of claim 13, further comprising diluting the fluid from the gas tank using the base unit.

17. The method of claim 13, further comprising sending instructions to the processor via wireless communications.

18. The method of claim 13, further comprising performing a calibration sequence using the processor.

19. The method of claim 13, further comprising controlling flow of the fluid using the valve and the processor.

20. The method of claim 13, wherein the valve of the base unit is closed prior to connecting the base unit to the control unit.
